(19) United States
(12) Patent Application Publication
(10) Pub. No.: US 2013/0318883 A1
(43) Pub. Date: Dec. 5, 2013

(54) CUTTING TOOLS MADE FROM STRESS FREE CBN COMPOSITE MATERIAL AND METHOD OF PRODUCTION

(71) Applicant: DIAMOND INNOVATIONS, INC., Worthington, OH (US)

(72) Inventors: Gerold Weinl, Alvsjo (SE); Torbjorn Selinder, Westerville, OH (US); Rui Shao, Dublin, OH (US)

(21) Appl. No.: 13/906,808

(22) Filed: May 31, 2013

Related U.S. Application Data
(60) Provisional application No. 61/653,699, filed on May 31, 2012.

(51) Int. Cl. B23B 27/14

(52) U.S. Cl. CPC B23B 27/148
USPC 51/298; 51/307; 51/309

(57) ABSTRACT

An insert for a cutting tool and a method of making an insert are provided. The insert for a cutting tool may comprise a body and a substrate carrier. The body may have a top, a bottom, and a plurality of side walls connected to the top and the bottom. The body may comprise superhard particles in absence of a support. The substrate carrier may have a recess. The bottom and the sidewall of the body may be adapted to be affixed to the recess of the substrate carrier.

### CROSS-REFERENCE TO RELATED APPLICATIONS

This application claims priority of provisional application No. 61/653,699, filed May 31, 2012. The application is related to co-pending application, titled “Sintered superhard compact for cutting tool applications and method of its production”, which claims priority of provisional application No. 61/653,779, filed on May 31, 2012. The application is further related to co-pending application, titled “Method of making a cBN material”, which claims priority of provisional application No. 61/653,686, filed on May 31, 2012.

### TECHNICAL FIELD AND INDUSTRIAL APPLICABILITY

The present disclosure relates generally to cutting tools, and specifically to cutting tools comprising sintered bodies free of residual stress and free standing superhard composite affixed onto a suitable cutting tool carrier of hard metal, such as cemented carbide hard metal.

Polycrystalline cubic boron nitride (PCBN), diamond and diamond composite materials are commonly used to provide a superhard cutting edge for cutting tools such as cutting tools used in metal machining.

The thin cBN composite material blanks for hard part turning are currently manufactured as sintered to cemented carbide hard metal, which is also called “supported”. They are manufactured in high pressure, high temperature (HPHT) processes where the cBN composite powder blend is first loaded in a refractory capsule together with a cemented carbide hard metal disc. Several such capsules are usually compiled into a high pressure cell core. During the HPHT process the material is subjected to pressures of at least 40,000 atmospheres, and temperatures in the range of 1300-1450° C. Under these conditions, the cBN composite powder blend sintered to fully dense, and the hard metal discs melt or at least become soft due to melting of cobalt in the discs.

During the HPHT sintering process, the cBN composite is fused to the hard metal. After HPHT sintering, pressure and temperature are lowered to ambient, and during this process, both the cBN composite and cemented carbide hard metal become a rigid solid. Because the cBN composite and the hard metal have different mechanical properties, such as bulk modulus, and thermal properties, such as thermal expansion, inevitable residual stress fields arise. This occurs particularly in the case of hard part turning cBN composites which, in most cases, have a ceramic based binder material with a significantly higher thermal expansion coefficient than the cemented carbide hard metal. As a result, the cBN composite layer is under tensile stress. FIG. 1 shows a cBN composite layer supported by cemented carbide hard metal. Residual stress analysis by X-ray diffraction (XRD) shows that the cBN composite layer has a tensile stress of 660 MPa. This tensile stress reduces the mechanical strength of the material and may lead to vertical cracks, as shown in FIG. 1 that are detrimental to the cutting tool performance.

The unfavorable state of tensile stress in the cBN composite layer may be avoided by using cermet hard metal discs in lieu of cemented carbide for supporting the cBN composite layer. Cermet hard metal may be designed to have a higher thermal expansion coefficient, so that the cBN composite material may be designed with a compressive residual stress. A moderately compressive residual stress may be beneficial, but if excessive, such compressive stress could lead to cracks in the cBN composite layer, which are parallel to the cBN composite/support layer interface.

FIG. 2 shows a crack in a cBN composite layer supported by cermet hard metal. The residual stress in this layer is around 1,400 MPa (compressive). Under mechanical load, such as in a machining operation, such layer would delaminate and spall off the supporting cermet hard metal. Most certainly, the person skilled in the art could circumvent such problems by tailoring the cermet hard metal composition so as to match its thermal and mechanical properties to those of various cBN composites, which, however, would not be a particularly desirable solution from a production process and cost point of view. In addition to this, there arises the problem of having to braze the cermet hard metal supported material to a cemented carbide based carrier, in which case cracks would arise as a result of different thermal expansion coefficients of cermet and cemented carbide.

Therefore, it can be seen that there is a need for a cutting tool made from stress-free superhard composite material to be used in toughness demanding operations, such as hard part turning.

### SUMMARY

In one embodiment, an insert for a cutting tool comprises a body having a top, a bottom, and a plurality of side walls connected to the top and the bottom, wherein the body comprises sintered superhard materials in absence of a support; and a substrate carrier having a recess, wherein the bottom and the sidewall of the body are adapted to be affixed to the recess of the substrate carrier.

In another embodiment, an insert for a cutting tool may comprise a stress-free body having a top, a bottom, and a plurality of side walls connected to the top and the bottom, wherein the stress-free body comprises superhard composites; and a substrate carrier having a recess, wherein the bottom and the sidewall of the body are adapted to be affixed to the recess of the substrate carrier.

In yet another embodiment, a method may comprise steps of blending a mixture of superhard particles with a binder material, such as ceramic and/or metallic powders with an organic binder material into a slurry; spray drying the slurry into granules with homogeneous composition, pre-compacting the granules into desired shape and size by die pressing, which is called “soft green”, heating a soft green body into a pre-sintered rigid body below 1000° C. by partially reacting raw materials into around 50% dense disc, containing intermediary phases, which is called “hard green”; loading a plurality of hard green bodies in a high pressure and high temperature (HPHT) cell core; applying high pressure high temperature conditions to sinter the presintered rigid bodies into dense superhard composite discs; removing the high pressure high temperature cell core from the high pressure high temperature conditions; retrieving the dense superhard composite discs from the high pressure high temperature cell; polishing superhard composite disc to a desired thickness; and cutting the dense superhard composite disc to a tip of a desired cutting tool insert; affixing, by for instance brazing, said tip to a recesses in a substrate carrier to form a cutting tool insert; grinding the cutting tool insert to a desired thickness and cutting edge geometry. The desired thickness may be less than 2.0 mm. In some embodiment, the desired thickness may be less than 1.4 mm.

### BRIEF DESCRIPTION OF THE DRAWINGS

The foregoing summary, as well as the following detailed description of the embodiments, will be better understood when read in conjunction with the appended drawings. It should be understood that the embodiments depicted are not limited to the precise arrangements and instrumentalities shown.

FIG. 1 is a cross sectional view of an optical image of a cemented carbide-supported tip showing vertical cracks due to residual tensile stress in the PCBN layer;

FIG. 2 is a cross sectional view of scanning electron micrograph (SEM) image of a cermet-supported tip showing a horizontal crack due to compressive stress in the PCBN layer;

FIG. 3 is a perspective view of an insert with a free standing PcBN tip affixed to a cutting tool according to an embodiment in use;

FIG. 4a is a schematic view of a refractory capsule with one hard green disc and one cemented carbide disc inside separated by a mica foil disc according to an embodiment;

FIG. 4b is a schematic view of a core where counterhold discs are inside refractory capsules according to an embodiment;

FIG. 5a is a schematic view of a cermet block formed by putting one mica foil disc on each side of a cermet disc according to an embodiment;

FIG. 5b is a schematic view of a hard green block formed by putting one Mo foil disc on each side of a hard green disc according to an embodiment;

FIG. 5c is a schematic view of a separation block formed by putting one mica foil disc on each side of a graphite foil disc according to an embodiment;

FIG. 5d is a schematic view of a cell core where counterhold discs are outside refractory capsules according to another embodiment;

FIG. 6 is an optical image of a cross-sectional view of a free standing PCBN tip showing no defects due to favorable stress-free condition;

FIG. 7 is a graph of flank wear progression for Example 1 and Example 2 compared with a commercial hard part turning grade;

FIG. 8a is a graph of flank wear progression for Example 3 and 4;

FIG. 8b is a graph of crater wear progression for Example 3 and 4; and

FIG. 8c is a graph of toughness test results for Example 3 and 4;

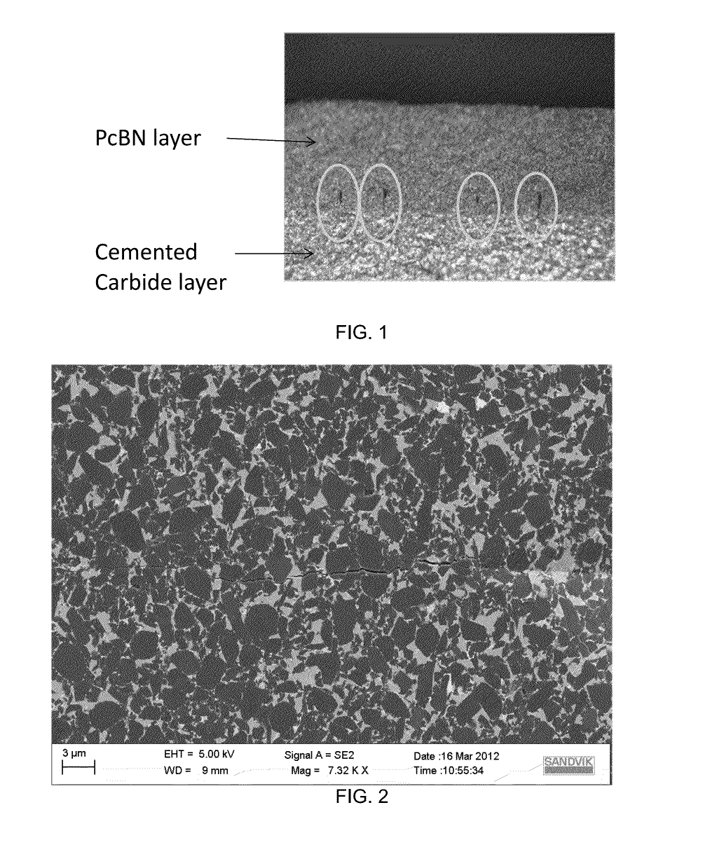

### DETAILED DESCRIPTION

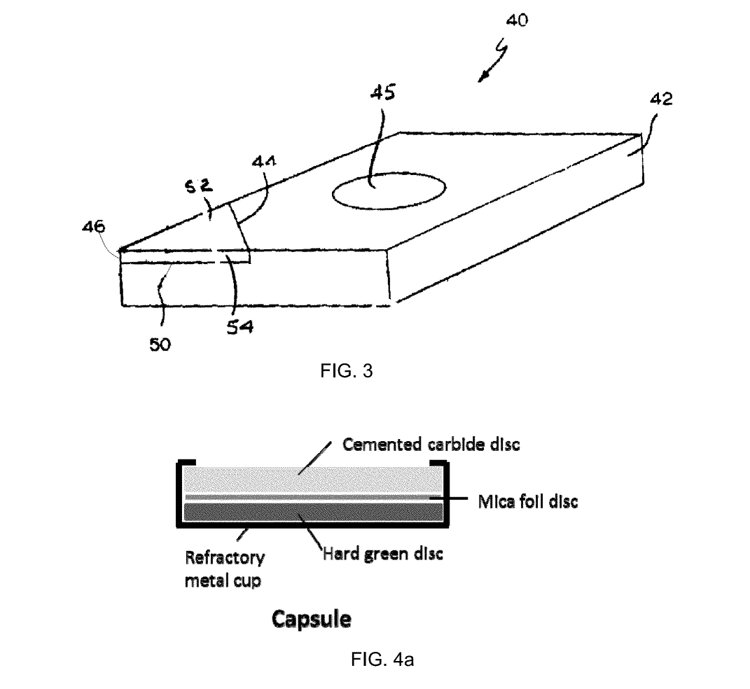

As used herein, the term “insert” refers to pieces of tungsten carbide or alternative cutting material mechanically held, brazed, soldered, or welded into position on dies, or substrate carriers, and discarded when worn out, others being fitted in their place. An example is illustrated in FIG. 3. Also see A Dictionary of Machining (Eric N. Simmons, Philosophical Library, New York, 1972).

As used herein, the term “substrate carrier” refers to a rigid body that holds a cutting tip or tips firmly in place so that they can be utilized in a turning, milling, boring, cutting, or drilling application.

An embodiment is made of a residual stress-free body affixed, by brazing techniques known in the art, to suitable substrate carriers, such as, cemented carbide hard metal cutting tool inserts. The residue stress-free body may comprise superhard particles. The superhard particles may be selected from a group of cubic boron nitride, diamond, and diamond composite materials. The residue stress-free cBN composite material is manufactured as thin free standing discs in absence of a support, such as a hard metal support. The hard metal support may comprise a tungsten carbide support. In one embodiment, the stress-free cBN composite material may be below 2.0 mm in thickness for example. In another embodiment, the stress-free cBN composite material may be 1.4 mm or thinner, for example, as measured after the HPHT process.

In one embodiment, the residue free standing cBN composite discs may have a cBN content in a range of 35 to 85 vol % cBN and a range from 15% to 65% ceramic compounds, including transition metal borides, carbides, nitrides, and oxy-carbonitrides or mixtures thereof, for example. In another embodiment, the free standing cBN composite discs may have 86-99 vol % cBN with a range from 1% to 14% of a mixture of ceramic compounds of metal borides, carbides, nitrides, and oxy carbonitrides, and residues, such as metallic elements or compounds of cobalt (Co), tungsten (W), aluminum (Al), titanium (Ti), nickel (Ni), for example. These discs have virtually no residual stress at all and are easy to cut to a desired shape. In an embodiment, a ratio of tungsten to cobalt is between 1.0-1.8.

It has not been possible to make such free standing discs before. In prior art, the cBN composite is made by mixing cBN and binder phase ceramic raw material powders that is loaded in refractory capsules of, such as, Tantalum (Ta), Molybdenum (Mo), or Niobium (Nb), for example. Because the loose powder does not get compressed and sintered flat enough, it may result in inhomogeneity and thickness variation that would bring the disc outside the required tolerance. In one embodiment, the cBN raw material is instead loaded into the HPHT cell core as pre-sintered rigid bodies. In an embodiment, discs may be compressed and sintered homogeneously to the required flatness and thickness tolerance.

In one embodiment, the free standing cBN composite discs may be made in a process comprising the steps of wet blending cBN and binder phase ceramic particles in a suitable organic solvent, such as ethanol; adding an organic binder material, such as polyethylene glycol (PEG), to the slurry; spray drying the prepared slurry into granules; die pressing the granules to soft green bodies containing the original raw material; removing the organic binder materials by heating the soft green bodies to less than 1,000° C., such as 400-500° C. in flowing hydrogen gas, and then further heat treating the soft green into pre-sintered rigid bodies (or “hard greens”) by partially reacting the raw material into intermediary phases in vacuum at temperatures above 700° C. and below 1100° C.; loading the hard green bodies in a HPHT cell core together with, but separated from cermet hard metal counterhold discs; applying HPHT conditions to sinter the pre-sintered rigid bodies into fully densed cBN composite discs; removing the cell core from HPHT conditions whereupon the free standing cBN composite discs may easily be retrieved; grinding or lapping the fully dense cBN composite to a desired final thickness tolerance and cutting out tips of a design suitable to affixing to desired substrate carriers; affixing, by, for instance, brazing, said tip to a recesses in a substrate carrier to form a cutting tool insert; grinding the cutting tool insert to a desired thickness and cutting edge geometry.

In some embodiments, partially reacting the raw materials into intermediary phases may be done in vacuum until the soft green bodies reach above approximately 700° C. and below 1,000° C., and then in a gas environment, such as nitrogen or argon, until the final temperature above 700° C. to below 1100° C.

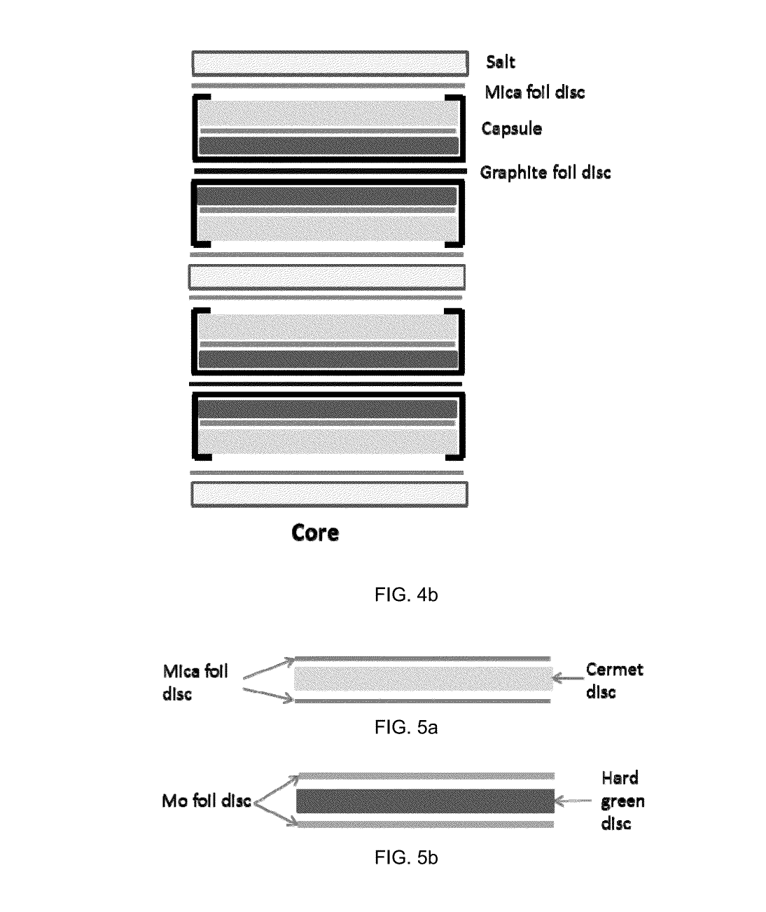

In one embodiment, hard greens may be loaded in individual refractory capsules. In some variants of this embodiment, several such individual refractory capsules may be stacked to build a complete HPHT cell core. It may be a central feature of an embodiment to include in the capsule content counterhold discs that serve the purpose of maintaining an even thickness of the hard green discs throughout the HPHT sintering process. It may be also essential to include a material, such as a mineral disc or non-reactive coating, inside the capsule between the hard green and the counterhold discs in order to keep them separated. The presintered rigid bodies may be separated by hard metal counterhold discs, such as cermet counterhold discs, in the high temperature high pressure cell core. FIG. 4a illustrates an example of such a capsule. FIG. 4b shows an embodiment of a HPHT cell core stack comprising a plurality of capsules with both hard green discs and counterhold discs in it.

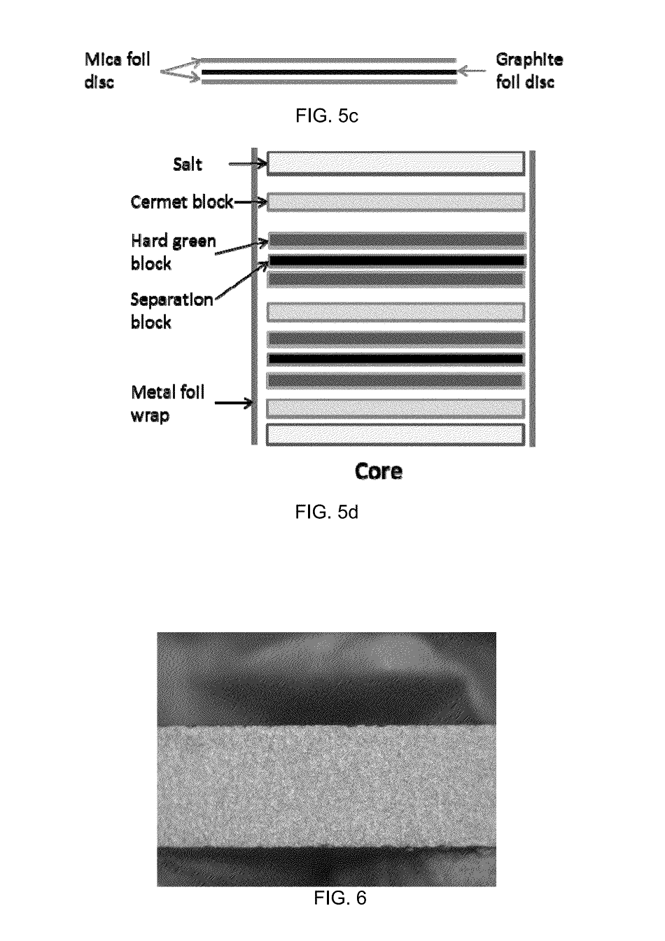

In one embodiment, the counterhold may be located outside the refractory capsules. FIG. 5a shows an example of such a counterhold, which is called cermet block in the example. FIG. 5b shows an example of such a capsule, which is called hard green block in the example. FIG. 5c shows a separation block formed by graphite foil and mica foil discs for keeping the hard green blocks separate during the HPHT sintering process. FIG. 5d shows an example of such embodiment with the counterhold outside the refractory capsules. Each hard green disc may be surrounded with refractory metal foils, which serves as individual capsules.

In such embodiment, the counterhold material is more critical than if the counterhold disc is included in the refractory capsule. Cemented carbide hard metal discs may not be suitable to serve as counterhold outside the refractory capsule, as cobalt in cemented carbide melts and the disc may deform plastically under HPHT conditions, where the cBN composite discs are sintered and become rigid discs while the cemented carbide discs are still soft. However, during cooling after HPHT sintering, the cemented carbide hard metal discs re-solidify, and the relative movement between the cBN composite and cemented carbide rigid discs during the depressuring process may crack the cBN composite discs. Ceramic discs may not be suitable as counterhold outside the refractory capsules because they are brittle and may crack before in the pressure ramp up phase. Steel counterhold, similar to cemented carbide, is far too soft at high temperatures. In summary, for HPHT sintering of cBN composites, the counterhold material needs to have enough toughness and compressive strength to keep its integrity during pressure ramp up; in the range of sintering temperatures, the counterhold material should not deform plastically too much so that the disc flatness is not compromised. It is found that counterhold discs made from cermet hard metal have enough rigidity and compressive strength and similar expansion, melting, and re-solidification patterns to those of the cBN composite material during the HPHT process. A high pressure cell designed with cermet hard metal counterhold may produce flat and stress free cBN composite discs.

In yet another embodiment, a multitude of hard greens may be loaded in one single refractory capsule of Ta, Mo, or Nb, or any other refractory metal. In such embodiments, the refractory capsule may contain counterhold discs, the stacking sequence so constructed that, each rigid pre-sintered disc may be separated from other discs by a suitable mineral material disc or non-reactive coatings, and/or refractory metal discs. In embodiments that use the refractory metal separating discs, the metal discs may be placed in direct contact with the rigid pre-sintered disc, creating an adherent metallic surface layer on the cBN composite which may be suitable for post HPHT processing, such as grinding or brazing.

FIG. 6 shows a cross-section view of a cBN composite material made in a HPHT cell with a core according to FIG. 5. This cBN composite material has a residual stress around 25 MPa measured by X-ray diffraction (XRD), which is considered stress free within the accuracy of the used XRD method. In fact all measured residual stresses with absolute values below 100 MPa may be considered stress free for the purpose.

Referring to FIG. 3, a cutting tool 40 may include a substrate carrier 42 that contains a recess 44 and an aperture 45. The substrate carrier 42 may be made from a number of materials, including cobalt cemented tungsten carbide. A free standing body 46 may have a top 52, a bottom 50, and a plurality of side walls 54 (or flanks) connected to the top 52 and the bottom 50. The bottom 50 and the sidewall 54 of the body 46 may be adapted to be affixed to the recess 44 of the substrate carrier 42. The bottom 50 and the sidewall 54 may be brazed to the recess 44 of the substrate carrier 42 by braze alloy, for example.

The free standing body may comprise superhard particles, which may be selected from a group of cubic boron nitride, diamond, and diamond composite materials. The free standing body may not have a support, such as a hard metal support, which includes tungsten carbide support. The free standing body may be a stress free body.

After brazing, the insert may go through standard insert finishing processes, such as top and bottom grinding, periphery grinding, and desired edge preparation and/or coating.

### Example 1

Powders of aluminum (6 wt %%), ZrN (6 wt %), ssTiN (58 wt %), and cBN (30 wt %) were milled in a roll mill with cemented carbide milling bodies in ethanol for 2 hours. After milling, the slurry was mixed with a PEG solution, and spray dried into spherical granules. The granules were pre-compacted into soft green discs, which are subsequently fired in vacuum at temperatures between 700° C. and 900° C. to form hard green discs. The hard green discs were loaded in a HPHT cell core as shown in FIG. 5, said core then enclosed in a Mo metal capsule and then HPHT sintered at temperatures about 1300° C. to 1450° C. with pressures of at least 2 GPa. After HPHT sintering, the disc thickness was about 1.3 mm. These discs were double disc lapped to 1 mm thick and cut by wire-electric discharge machining (wire-EDM) into triangular tips. The tips are cleaned and brazed onto carbide carriers with active braze alloy at temperatures between 800 to 850° C. After brazing, the inserts were processed through standard finishing procedures.

### Example 2

Powders of aluminum (5 wt %%), TiCN (32 wt %), ssTiN (32 wt %), and cBN (31 wt %) were milled in an attritor mill with cermet milling bodies in ethanol for 5 hours. After milling, the slurry was mixed with a PEG solution and spray dried into spherical granules. The granules were pre-compacted, pre-sintered and HPHT sintered in the same way as those of Example 1. The tips are cut and brazed, and the inserts were finished in the same way as described in Example 1.

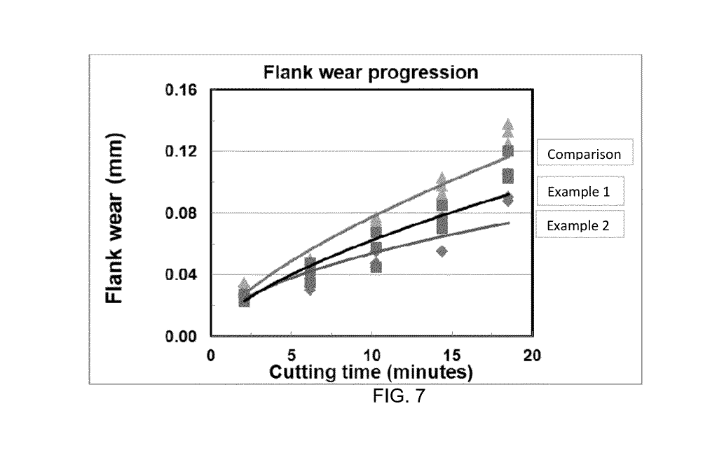

FIG. 7 shows the flank wear test results on Example 1 and Example 2 compared with a commercial hard part turning grade, which is referred to as “comparison” in FIG. 7. The test was conducted on 8620 steel with continuous cutting. Cutting was stopped every 2 to 4 minutes, and flank wear was measured and recorded. It could be seen that the comparison grade shows the highest flank wear, with Example 2 as the lowest flank wear and Example 1 in the middle. The same wear test was conducted with an extended cutting time for one sample of each from Example 1, Example 2 and the same comparison grade. After around 45 minutes of cutting, Example 1 has 0.08 mm flank wear; Example 2 has 0.06 mm flank wear, while the comparison grade had around 0.10 mm flank wear.

### Example 3

Powders of aluminum (5 wt %%), substoichiometric TiN (59 wt %), ZrN (6 wt %) and cBN (30 wt %) were milled in roll mill with cemented carbide milling bodies in ethanol for 2 hours. After milling, the slurry was mixed with a PEG solution and the following spray drying, pre-compacting, pre-sintering processes were the same as described in Example 1. The hard green discs were individually loaded together with a cemented carbide disc as counterhold each in Ta refractory material capsules. There was no separation material between the hard green disc and counterhold disc in each capsule. Four such capsules were loaded in a cell and HPHT sintered at temperatures about 1300° C. to 1450° C. with pressures of at least 2 GPa. After HPHT sintering, the cBN composite layer and the cemented carbide disc were fused together. These discs were referred to as supported discs. The supported discs went through OD grinding and surface grinding to make a disc with a PCBN layer of 1 mm thick and with a total thickness of 3.2 mm.

### Example 4

Four hard green discs were made in the same as described in Example 3. Hard green discs were loaded in Ta capsules together with cemented carbide discs in a similar way as described in Example 3, but each hard green disc was separated by hard metal counterhold discs, such as cemented carbide disc with a mica foil disc in between to make free standing discs. Four such capsules were loaded in a HPHT cell, as shown in FIG. 4. After HPHT sintering at the same conditions as Example 3, the free standing cBN composite discs were pad lapped on the mica side to about 1 mm thickness.

Both the supported and free standing discs were then cut by wire-electrical discharge machining (wire-EDM) to tips. The tips were brazed and the inserts were finished in the same way as described in Example 1.

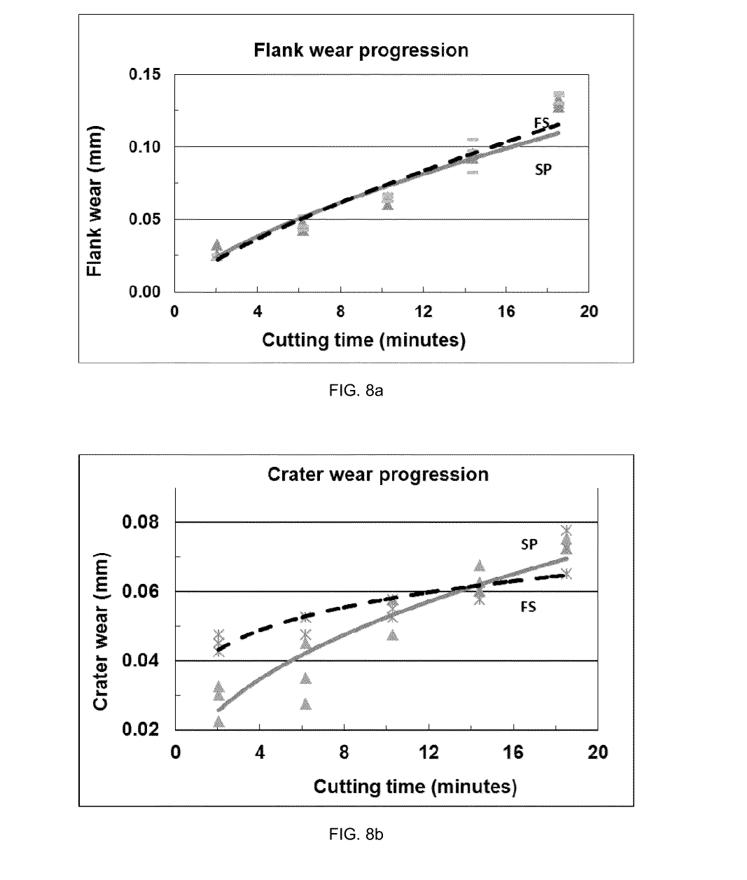

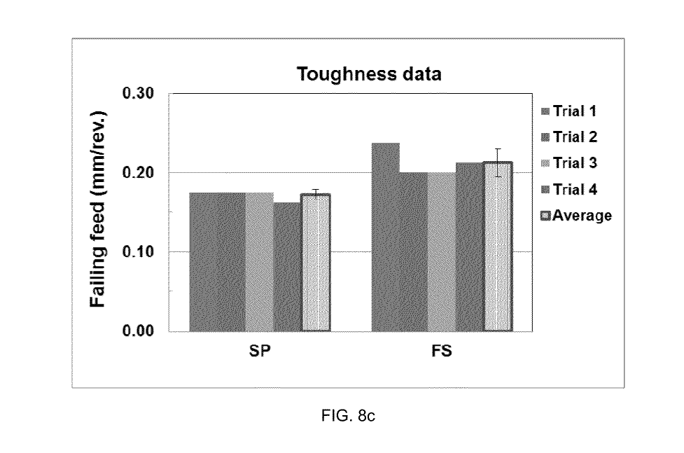

Both wear resistance and toughness were tested on Example 3 and 4. The wear test was conducted on 8620 steel with continuous cutting. Cutting was stopped every 2 to 4 minutes, and flank wear and crater wear were measured and recorded. The toughness test was conducted on 52100 steel with hardness of Rc 60 to 62. Four samples of each variant were tested. FIG. 8 showed the machining results on flank wear (FIG. 8a), crater wear (FIG. 8b) and toughness (FIG. 8c). In FIG. 8, the free standing inserts were referred to as “FS”, and the supported inserts are referred to as “SP”. These two materials show the same flank wear resistance. The free standing inserts show better crater wear resistance and better toughness than the supported inserts, even though the cBN composite material compositions in both cases are identical.

### Example 5

Powder blends with cBN contents of 38 vol %, 47 vol %, 55 vol %, 65 vol %, 75 vol % and 85 vol %, and TiCNO and Al as the binder materials, were made by milling in a roll mill with cermet milling bodies for 25 hours. The slurries were then mixed with polyethylene glycol (PEG) solutions and the following spray drying, pre-compaction and pre-sintering processes were the same as described in Example 1. In the following HPHT sintering process, both cemented carbide supported and free standing discs were made. All the cemented carbide supported cBN composite discs sintered well except for the 85% cBN variant. For the 85% cBN variant, Co in the cemented carbide infiltrated in the cBN composite layer during HPHT sintering, which helped improve the sintering quality, while in the case of free standing, no extra Co was available, which led to poor sintering. However, the concept of free standing is still possible for high cBN variants such as 85 vol % to 99 vol % by some methods such as follows.

One method is to introduce more Co or Co/W by blending in powders containing Co or Co/W, or by milling for a long period of time to increase the amount of mill debris, from milling bodies of cementer carbide or cermet, for example, in the blends. Another way would be adding thin foil discs of Co or Co/W containing materials that are in contact with the hard green discs in the core design as shown in FIGS. 4 and 5, where the Co or Co/W containing foil melts under HPHT conditions and infiltrates in the cBN composite layer. After HPHT, only a very thin layer, which may be 10% of the thickness of the cBN composite layer, of Co or Co/W metal may be left on top of the cBN composite disc, and the thin layer is not thick enough to cause residual stresses that are harmful to the cBN composite disc. The thin layer of Co or Co/W containing material may be easily removed by lapping or grinding.

While reference has been made to specific embodiments, it is apparent that other embodiments and variations can be devised by others skilled in the art without departing from their spirit and scope. The appended claims are intended to be construed to include all such embodiments and equivalent variations.

We claim:

1. An insert for a cutting tool, comprising:
a body having a top, a bottom, and a plurality of side walls connected to the top and the bottom, wherein the body comprises superhard particles in absence of a support; and
a substrate carrier having a recess, wherein the bottom and the plurality of sidewalls of the body are adapted to be affixed to the recess of the substrate carrier.

2. The insert for a cutting tool of claim 1, wherein the superhard particles are selected from a group of cubic boron nitride, diamond, and diamond composite materials.

3. The insert for a cutting tool of claim 1, wherein the superhard particles comprise cubic boron nitride in a range from 35% to 99% by volume.

4. The insert for a cutting tool of claim 1, wherein the superhard particles comprise cubic boron nitride in a range from 35% to 85% by volume.

5. The insert for a cutting tool of claim 4, further comprises ceramic compounds in a range from 15% to 65% by volume.

6. The insert for a cutting tool of claim 5, wherein the ceramic compounds are selected from a group of transition metal borides, carbides, nitrides, and oxy carbonitrides.

7. The insert for a cutting tool of claim 1, wherein the superhard particles comprise cubic boron nitride in a range from 86% to 99% by volume.

8. The insert for a cutting tool of claim 7, further comprising ceramic compounds and residues in a range from 1% to 14%.

9. The insert for a cutting tool of claim 8, wherein the ceramic compounds are selected from a group of transition metal borides, carbides, nitrides, and oxy carbonitrides.

10. The insert for a cutting tool of claim 8, wherein the residues comprise metallic elements or compounds.

11. The insert for a cutting tool of claim 10, wherein the metallic elements or compounds include tungsten, cobalt, or tungsten-cobalt alloy.

12. The insert for a cutting tool of claim 11, wherein a ratio of tungsten to cobalt is between 1.0-1.8.

13. The insert for a cutting tool of claim 11, wherein the body is a stress free body.

14. The insert for a cutting tool of claim 11, wherein the body is less than 2.0 mm thick.

15. The insert for a cutting tool of claim 11, wherein the body is less than 1.4 mm thick.

16. The insert for a cutting tool of claim 11, wherein the bottom and the sidewall of the body are brazed onto the recess of the substrate carrier.

17. The insert for a cutting tool of claim 1, wherein the support is a hard metal support.

18. The insert for a cutting tool of claim 17, wherein the hard metal support is a tungsten carbide support.

19. An insert for a cutting tool, comprising:
a stress free body having a top, a bottom, and a plurality of side walls connected to the top and the bottom, wherein the stress free body comprises superhard particles; and
a substrate carrier having a recess, wherein the bottom and the plurality of sidewalls of the body are adapted to be affixed to the recess of the substrate carrier.

20. The insert for a cutting tool of claim 19, wherein the superhard particles are selected from a group of cubic boron nitride, diamond, and diamond composite materials.

21. The insert for a cutting tool of claim 19, wherein the superhard particles comprise cubic boron nitride in a range from 35% to 99% by volume.

22. The insert for a cutting tool of claim 19, wherein the superhard particles comprise cubic boron nitride in a range from 35% to 85% by volume.

23. The insert for a cutting tool of claim 22, further comprises ceramic compounds in a range from 15% to 65% by volume.

24. The insert for a cutting tool of claim 23, wherein the ceramic compounds are selected from a group of transition metal borides, carbides, nitrides, and oxy carbonitrides.

25. The insert for a cutting tool of claim 19, wherein the superhard particles comprise cubic boron nitride in a range of from 86% to 99% by volume.

26. The insert for a cutting tool of claim 25, further comprising ceramic compounds and residues in a range of from 1% to 14%.

27. The insert for a cutting tool of claim 26, wherein the ceramic compounds are selected from a group of transition metal borides, carbides, nitrides, and oxy carbonitrides.

28. The insert for a cutting tool of claim 26, wherein the residues comprise metallic elements or compounds.

29. The insert for a cutting tool of claim 28, wherein the metallic elements or compounds include tungsten, cobalt, or tungsten-cobalt alloy.

30. The insert for a cutting tool of claim 29, wherein a ratio of tungsten to cobalt is between 1.0-1.8.

31. The insert for a cutting tool of claim 29, wherein the stress free body does not have a support.

32. The insert for a cutting tool of claim 31, wherein the body is less than 2.0 mm thick.

33. The insert for a cutting tool of claim 32, wherein the body is less than 1.4 mm thick.

34. A method, comprising:
blending superhard particles with a binder material into a slurry;
heating a soft green body into a presintered rigid body by partially reacting raw materials into intermediary phases; and
loading a plurality of presintered rigid bodies in a high pressure high temperature cell core.

35. The method of claim 34, further comprising adding an organic binder material to an organic solvent of the binder phase.

36. The method of claim 34, further comprising spray drying the slurry into granules.

37. The method of claim 34, further comprising pre-compacting the granules to the soft green body by die pressing.

38. The method of claim 34, further comprising applying high pressure high temperature conditions to sinter the presintered rigid bodies into dense superhard composite discs.

39. The method of claim 34, further comprising removing the high pressure high temperature cell core from the high pressure high temperature conditions.

40. The method of claim 39, further comprising retrieving the dense superhard composite discs from the high pressure high temperature cell.

41. The method of claim 40, further comprising polishing the dense superhard composite disc to a desired thickness.

42. The method of claim 41, further comprising cutting the dense superhard composite disc to a tip of a desired cutting tool insert.

43. The method of claim 34, wherein the presintered rigid bodies are separated by hard metal counterhold discs in the high temperature high pressure cell core.

44. The method of claim 43, wherein the hard metal counterhold discs are cermet counterhold discs.

45. The method of claim 35, wherein the organic solvent is ethanol.

46. The method of claim 35, wherein the organic binder material is polyethylene glycol.

47. The method of claim 38, wherein the high temperature to sinter the presintered rigid bodies into dense superhard composite discs is below 1000° C.

48. The method of claim 34, wherein the binder material comprises TiCNO, sub-stoichiometric (ss) Ti compounds, and an aluminum powder.

49. The method of claim 34, wherein heating the soft green body into the presintered rigid body below 1000° C.

50. The method of claim 34, wherein the desired thickness is less than 2.0 mm.
